(19) United States
(12) Patent Application Publication
(10) Pub. No.: US 2006/0245180 A1
(43) Pub. Date: Nov. 2, 2006

(54) Light with a rotatable lamp head

(76) Inventor: Nien-Piao Hsu, Chu Pei City (TW)

Correspondence Address: BIRCH STEWART KOLASCH & BIRCH, PO BOX 747, FALLS CHURCH, VA, 22040-0747, US

(21) Appl. No.: 11/411,869

(22) Filed: Apr. 27, 2006

(30) Foreign Application Priority Data
May 2, 2005 (TW) 094206963

(51) Int. Cl. F21L 4/00

(52) U.S. Cl. 362/157

(57) ABSTRACT

A light with a rotatable lamp head includes a lamp head, a lamp head socket, a second circuit board, and battery housing. The lamp head having at least one light source for emitting light beams, a first circuit board for controlling the light source, a switch which electrically connected to the circuit board for switching on/off the light source by pressing a button set on the switch and a tenon. The lamp head socket has a positioning recess. The positioning recess is used for connecting with the tenon to adjust the lamp head into multi-direction. The second circuit board setting on the lamp head socket and electrically connected to the lamp head by electric wires. The battery housing for installing at least a battery and using the battery to supply an electrical power to the lamp head through the second circuit board.

### BACKGROUND OF THE INVENTION

(a) Field of the Invention

The present invention relates to a light, especially, relates to a light with a rotatable lamp head.

(b) Description of the Related Art

Referring to FIG. 1, a conventional light 10 is illustrated. The conventional light 10 includes a battery housing 11, a lamp head socket 12, a light reflector 13, a light source 14, and a cover 15 used for protecting the light source 14. The light source 14 is made from an LED or a traditional lamp. The lamp head socket 12 is fixed to the battery housing 11 in the manner of screw connection. The lamp head socket 12 includes a light reflector 13, a light source 14, a cover 15, and a switch for turning on/off the light 10. In one embodiment, the switch of the light 10 is set on the outer side of the battery housing 11. In another embodiment, the conventional light 10 is turning on/off by twisting lamp head socket. The light reflector 13 can increase the brightness of the light further. The cover 15 is used for protecting the light reflector 13 and preventing the light source 14 from damages.

However, the lamp head socket 12 of the conventional light 10 is fixed so that it can not change its direction. As a result, the usage of the conventional light 10 is subject to limitation. When a user wants to fix the direction of the illumining for a longer period of time, he needs to hold the conventional light 10 by hand for a period of time, or use a string or another external means to adjust and fix the direction of the lamp head socket 12 in a certain direction. When a user hangs the conventional light 10 to illumine something, he can't easy to adjust the direction of the illumining at his own will. As a result, the usage of the conventional light 10 is subject to greater limitation.

### BRIEF SUMMARY OF THE INVENTION

The present invention provides a light with a rotable lamp head. The light with a rotatable lamp head includes a lamp head, a lamp head socket, a second circuit board, and battery housing. The lamp head having at least one light source for emitting light beams, a first circuit board for controlling the light source, a switch which electrically connected to the circuit board for switching on/off the light source by pressing a button set on the switch and a tenon. The lamp head socket has a positioning recess. The positioning recess is used for connecting with the tenon to adjust the lamp head into multi-direction. The second circuit board setting on the lamp head socket and electrically connected to the lamp head by electric wires. The battery housing for installing at least a battery and using the battery to supply an electrical power to the lamp head through the second circuit board.

Through the design of the invention, the inventive light can rotate its lamp head by the connecting of the positioning recess and the tenon. So, the user can use the light to emit light beams into multi-direction at the same time.

### BRIEF DESCRIPTION OF THE DRAWINGS

FIG. 1 shows a cross-sectional view of a conventional light.

FIG. 2 shows an exploded view of the light with a rotatable lamp head according to the present invention.

FIG. 3 shows a schematic illustration showing the up and down rotary positioning of the light with a rotatable lamp head according to the present invention.

FIG. 4 shows a schematic illustration showing the right and left rotary positioning of the lamp head of the light with a rotatable lamp head according to the present invention.

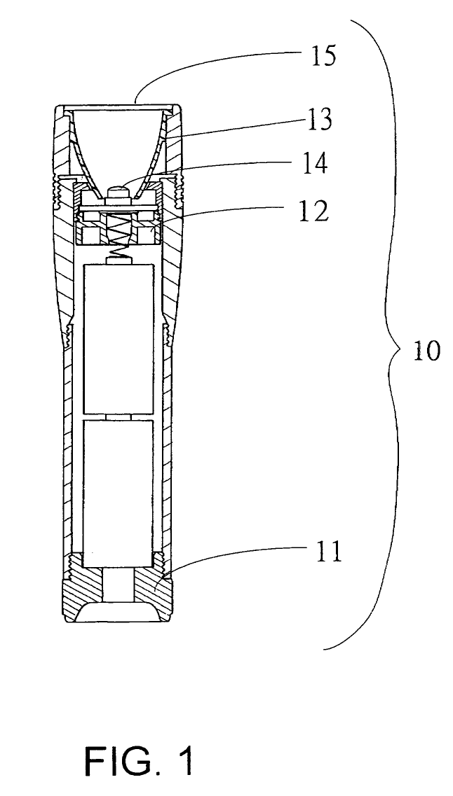

### DETAILED DESCRIPTION OF THE INVENTION

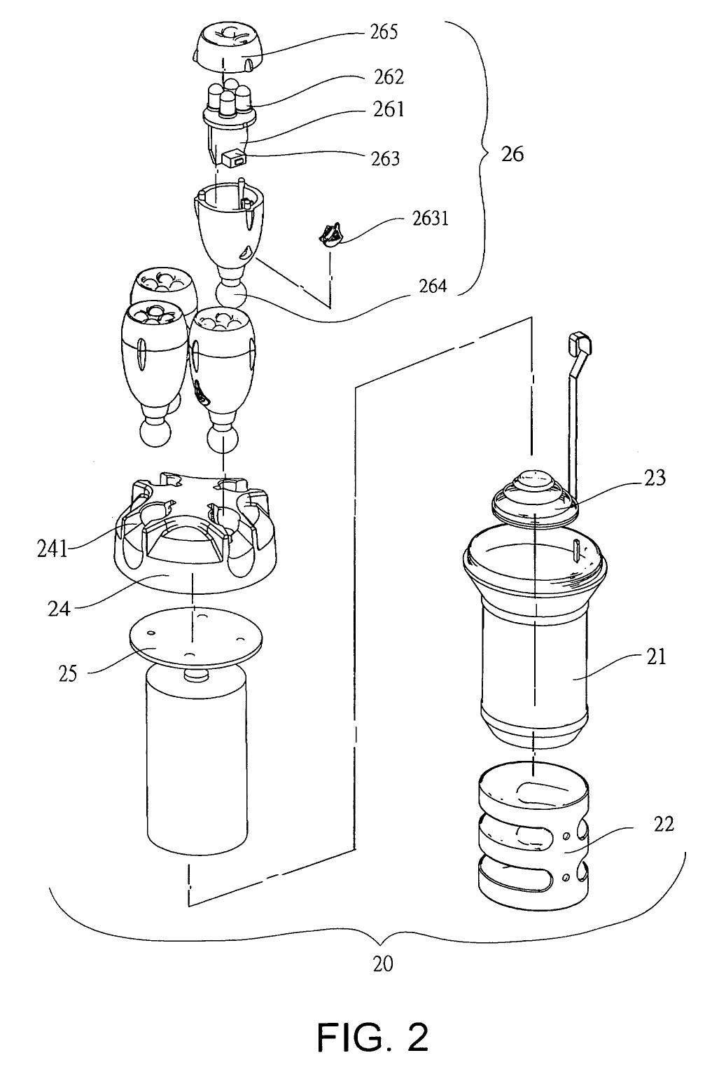

According an embodiment of the present invention, a light with a rotatable lamp head is provided. Referring to FIGS. 2, 3 and 4, the light 20 with a rotatable lamp head includes a battery housing 21, a slippery proof cover 22 covering the battery housing 21, a metal spring assembly 23, a lamp head socket 24, at least one positioning recess 241 set on lamp head socket 24, a circuit board 25 set on lamp head socket 24, at least one lamp head 26, at least one circuit board 261 set on lamp head 26, at least one light source 262 having a high power light emitting ability, at least one switch 263, a tenon 264 used for setting on the positioning recess 241, a lid 265 used for protecting the light source 262. The metal spring assembly 23 is set on the battery housing 21, and it let the battery have electrical connection with the circuit board 25 to form an electric conduction passageway.

The positioning recess 241 is set on the lamp head socket 24. The tenon 264 at the end of lamp head 26 is used for inserting into the positioning recess 241. The inner section of the positioning recess 241 is formed as a hollow.

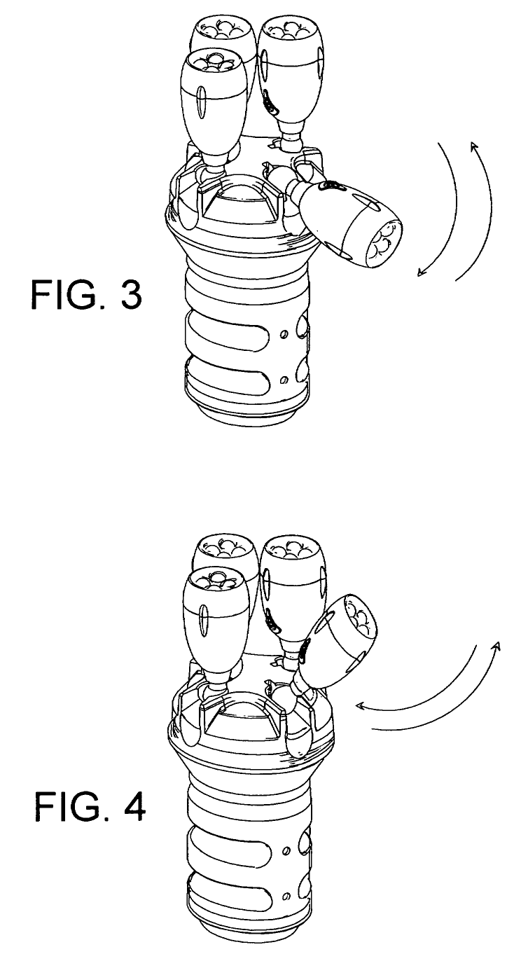

A set of circuit board 261 is set on each lamp head 26. The inside of the tenon 264 may be made as a hollow. When the tenon 264 is inserted into the positioning recess 241 on the lamp head socket 24, the tenon 264 is tightly coupled with the positioning recess 241 so that the lamp head 26 is capable of being adjusted to any direction by the user, as shown in FIGS. 3 and 4.

Electric wires in the circuit board 261 is designed to pass through the hollow of the inside area of the tenon 264, and generates electrical connection with circuit board 25 to form an electric conduction passageway. The light source 262 is in connection with the circuit board 261. The switch 263 turns the light source 262 on/off by pressing the button 2631 of the switch 263 to make the button 2631 in contact with the switch 263. The tenon 264 is inserted into the positioning recess 241 in the manner that the lamp head 26 is rotatable to change its direction of the illumining into multi-direction. So, the lamp head 26 can be adjusted up and down (as shown in FIG. 3) or right and left (as shown in FIG. 40). The range of changing the direction of the illumining is accorded to the design of the positioning recess 241. When the rotatable lamp head 26 of the light 20 is adjusted toward upper side, the bottom section of the light 20 can be placed on a plane article. When the light 20 with a rotatable lamp head is hanged or held by a user, it is possible to adjust the direction of the lamp head 26 to a place at which the user want to emit light beams.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein.

What is claimed is:

1. A light with a rotatable lamp head, comprising:
a lamp head having at least one light source for emitting light beams, a first circuit board for controlling the light source, a switch which electrically connected to the circuit board for switching on/off the light source by pressing a button set on the switch and a tenon;
a lamp head socket having a positioning recess which is used for connecting with the tenon to adjust the lamp head into multi-direction;
a second circuit board setting on the lamp head socket and electrically connected to the lamp head by electric wires; and
a battery housing for installing at least a battery and using the battery to supply an electrical power to the lamp head through the second circuit board.

2. The light as claimed in claim 1, wherein the battery housing is covered with a slippery proof cover.

3. The light as claimed in claim 1, wherein the battery housing is using a metal spring assembly to let the battery have electrical connection with the second circuit board.

4. The light as claimed in claim 1, wherein the light source is an LED.

5. The light as claimed in claim 1, wherein the light source having a lid used for protecting the light source.
